(19) United States
(12) Patent Application Publication
(10) Pub. No.: US 2007/0215657 A1
(43) Pub. Date: Sep. 20, 2007

(54) Model T. sleever bar holder

(76) Inventor: Tucson Allan Stewart, Laveen, AZ (US)

Correspondence Address: Tucson Allan Stewart, 6536 W Fremont Rd, Laveen, AZ, 85339, US

(21) Appl. No.: 11/348,421

(22) Filed: Mar. 20, 2006

(51) Int. Cl. A01K 97/04; F42B 39/02; A01K 97/06

(52) U.S. Cl. 224/197; 224/904; 224/674

(57) ABSTRACT

The Model T. Sleever Bar Holder is a new carrier/keeper for a Sleever bar tool. The Model T. Sleever bar holder swivel's 360 degrees. The swivel feature allows the bar to spin when the bar needs to be used yet it will not come out of or slip from the holder. The feature of the leather loop attached to the steel plate allows the Sleever bar holder to slide easily on to an existing tool belt. The Model T. Sleever Bar holder is hand crafted. It rides high on the belt by a tunnel leather loop attached to a steel plate. The utility feature of the Sleever bar holder further provides a means to carry a sleever bar tool used by Iron workers in the Iron working industry. The holder is useful and necessary. I claim the Utility feature/ornamental design for a Model T. Sleever Bar tool holder.

The Utility/Design consists of the visual ornamental characteristics embodied in, or applied to, an article of manufacture. The utility of the Model T. Sleever Bar Holder is useful and necessary. Independent designer demonstrates a useful holder for ironworker in order to carry a bulky sleever bar needed in ironwork industry. The independent designer asserts that the design features provide safety. The utility feature provides a secure holding place for the existing sleever bar used by iron workers. The Model T. Holder is a functional tool belted holder that provides relief to the worker from lifting the heavy sleever bar from a tool belt. The leather loop allows iron workers to easily slip the Model T. Holder onto the existing tool belt or to use it on a belt of choice.

Independent designer asserts the art design and utility of the Model T. Holder is custom made with heavy gauge steel and steel products to assemble has been tested and worn by ironworkers and was found to be user friendly. The bar maintains the center of gravity regardless of the angle or position the ironworker finds himself in. Whether climbing iron or bending over. The 360 degree swivel feature allows the sleever bar to spin when the bar needs to be used yet it will not come out of, spin, or slip by itself or from the holder unless user moves it manually. The bar must be pulled out of the holder in order to use the bar.

Independent designer asserts the easy access opening and secure closure provides the user the best means to carry the sleever bar. Asserts the Model T. Sleever Bar Holder has welded metals together with steel plug inside that bonds the product together. Independent designer asserts The Model T. Holder by design and utility has proven it is best holder for the sleever bar in the field. The best fit for iron workers.

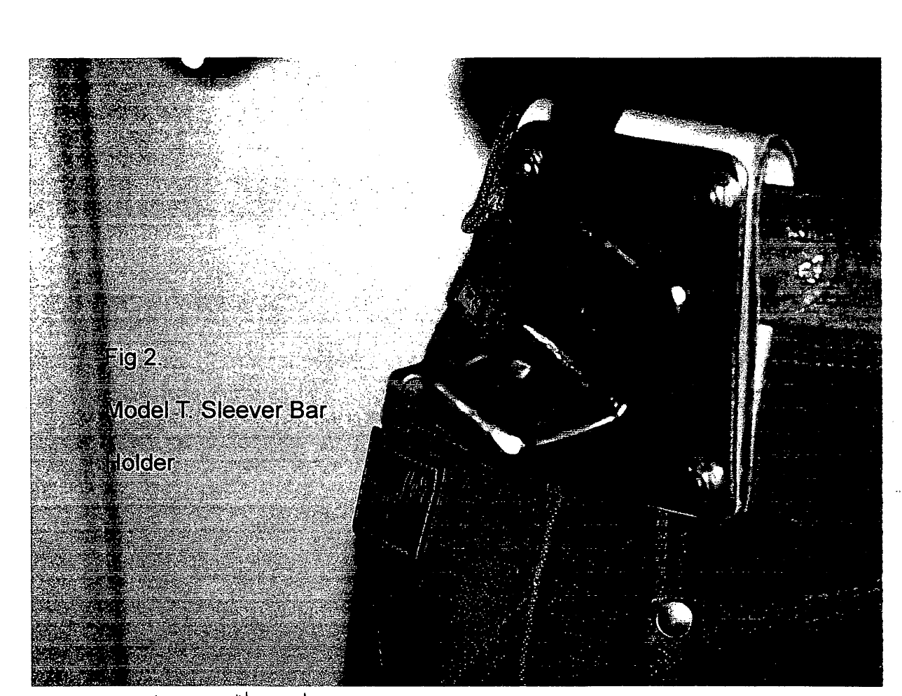

FIG. 1. L Angle steel bracket ¼″ inch thick with one 1″ inch hole bore into the center bottom one ½″ inch hole bore into the top back.

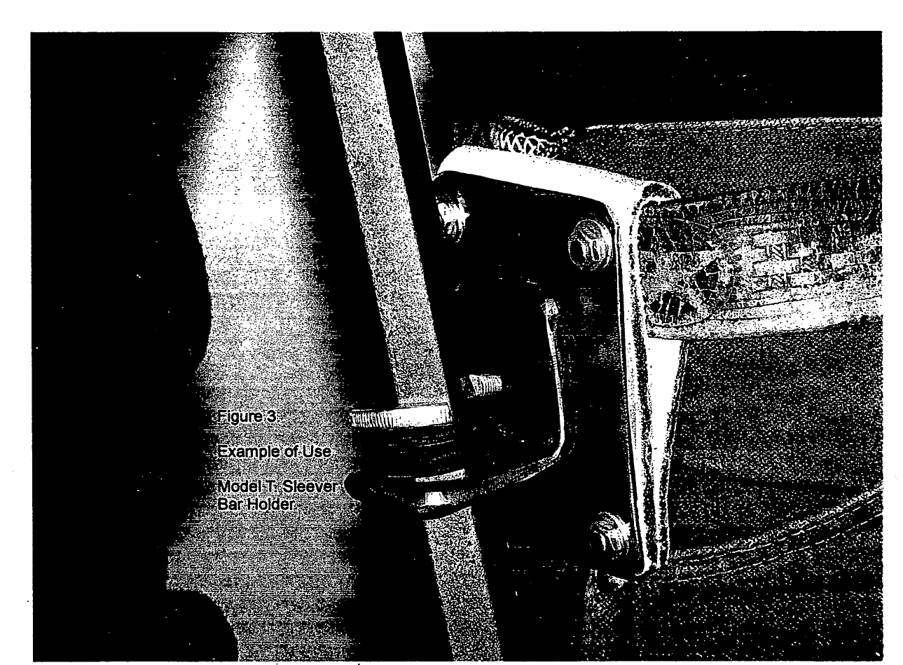

FIG. 2. Three steel ½″ inch in diameter ½″ inch hole in center Fender washers.

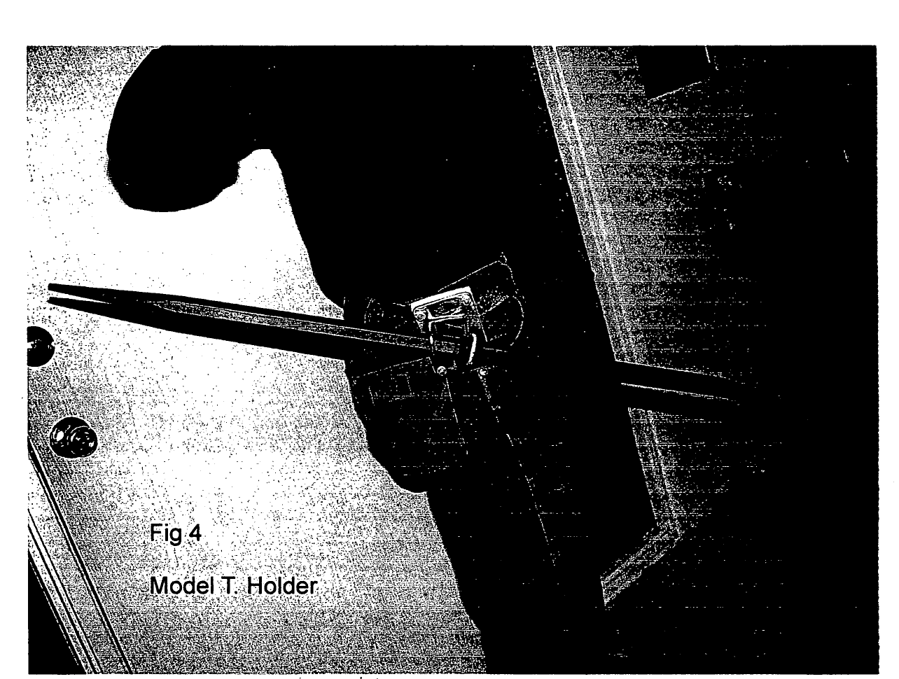

FIG. 3. One ½″ inch in diameter 1″ inch in length solid steel rod creates a steel center bonding peg.

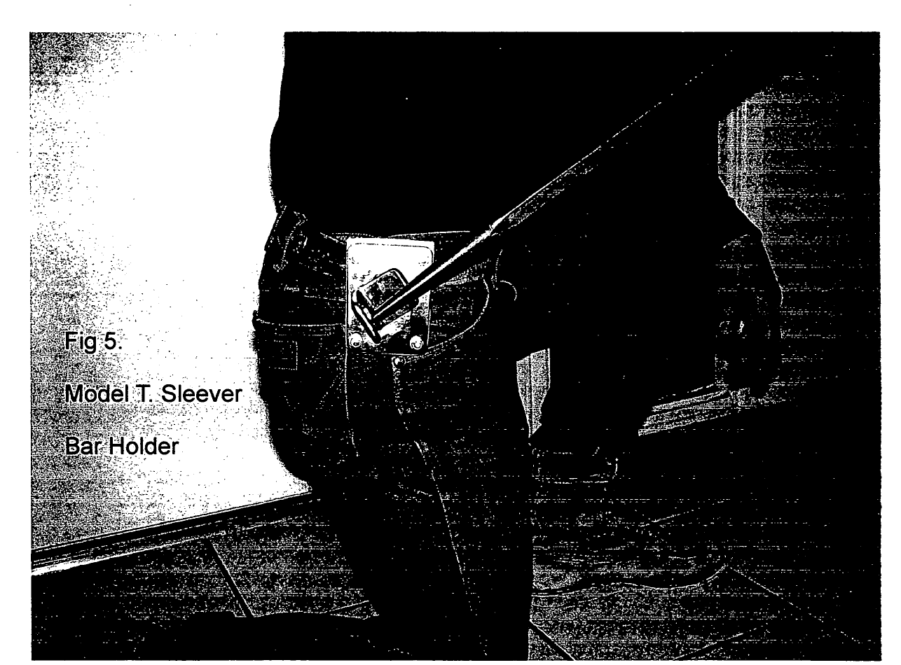

FIG. 4. ⅛″ Steel back plate with four 3/16″ inch holes drilled into each corner. One ⅛″ inch thick steel. Center ½″ hole drilled in plate.

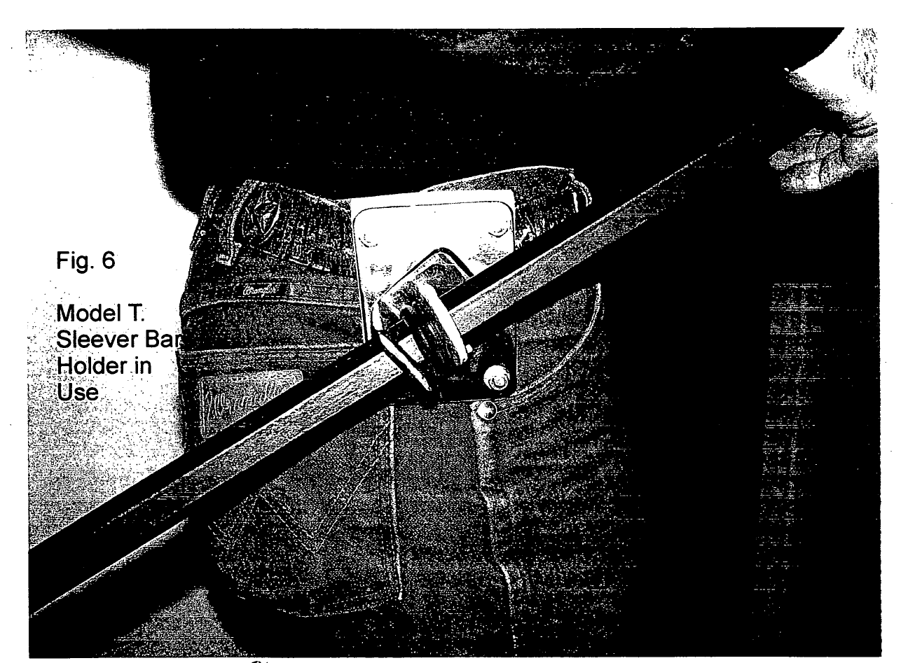

FIG. 5. Four 10-24 inch by 1″ inch round head R-H machine screws.

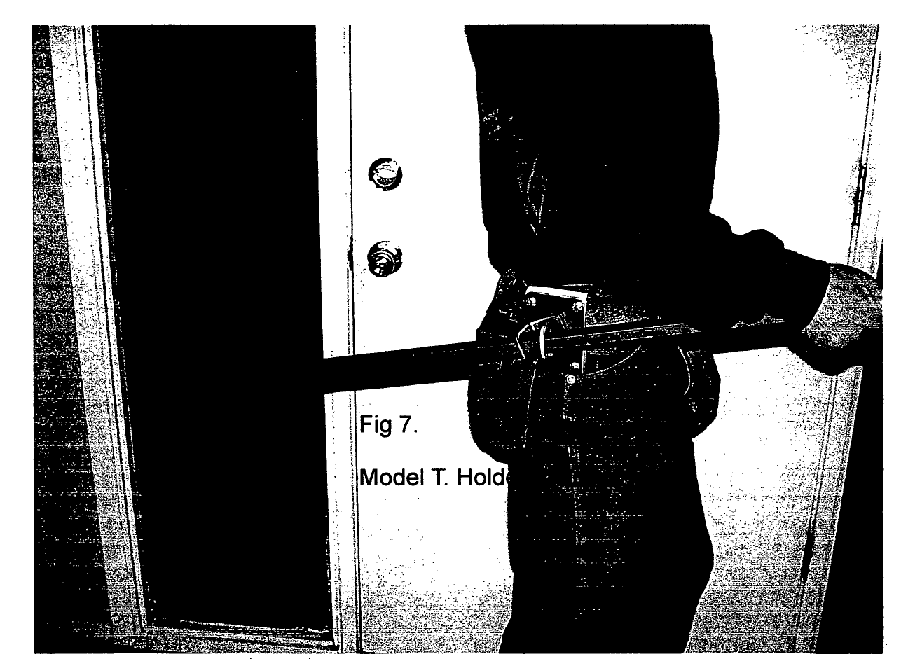

FIG. 6. Four 10-24″ inch Hexagonal machine nuts and eight 10-24″ flat washers.

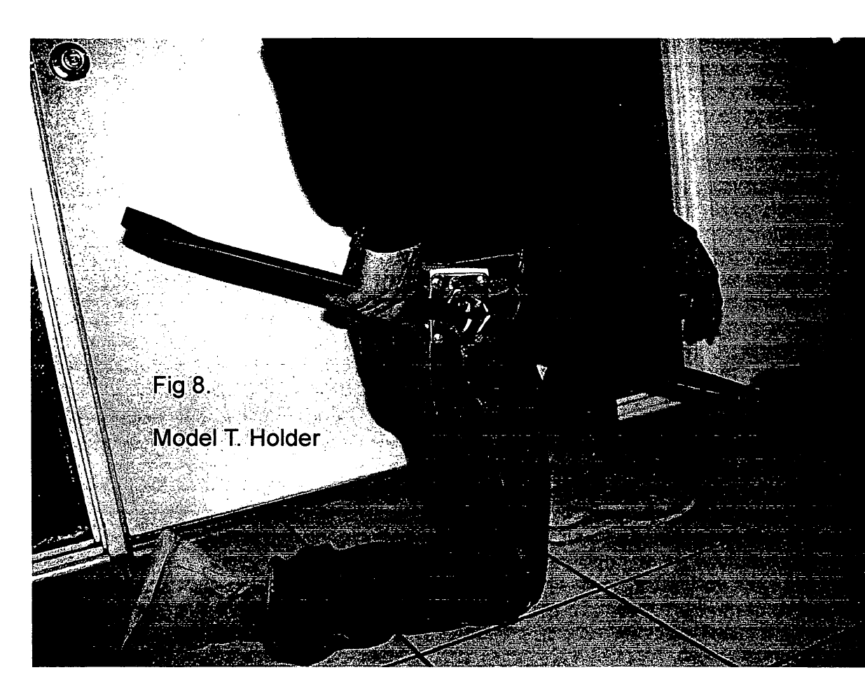

FIG. 7. One 4″ wide and 9″ inch long 3/16″ inch thick strip of leather.

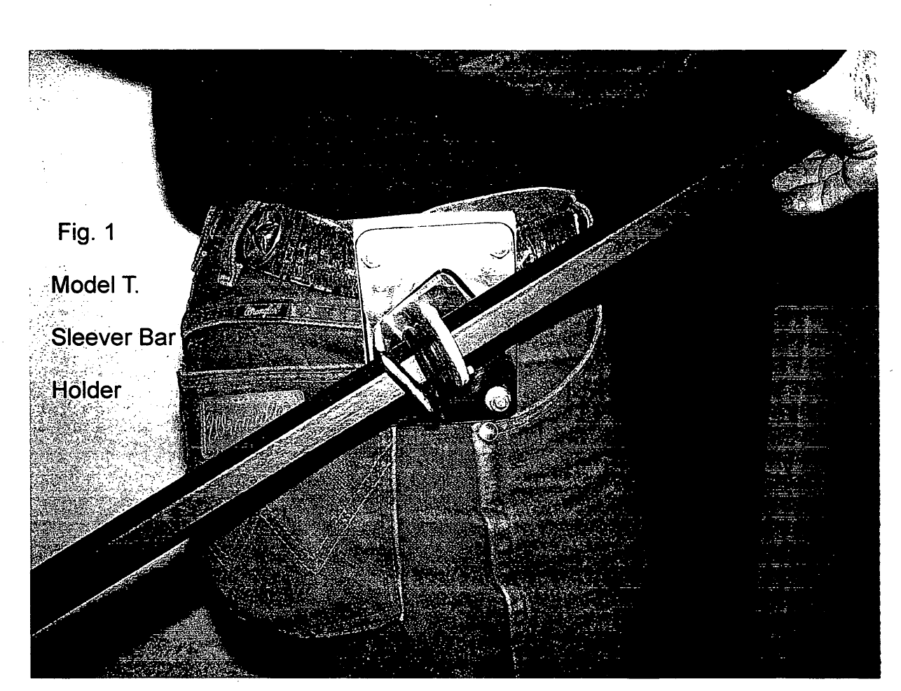

FIG. 0 Sleever Bar Example:

Union Ironworkers use Sleever Bar as a standard tool of choice Sleever Bars come in Hexagonal and Round shape. The Sleever Bars are made by industry in different lengths. The utility and design of current bar holders lack in that there are many in the field that are custom made that do not stand up to the test in the field. After contacting OSHA and testing the utility and design of the Model T keeper in the field the Model T proved to be the best fit for ironworkers to use.

One of the best features of the Model T keeper after being tested in the field has been proven it distributes the weight of the bar evenly when the leather belt loop slide is attached to the existing tool belt or waist belt it will stay firmly in place with no movement. The Model T keeper feature of having the 160 degree swivel will allow the sleever to spin when the ironworker needs to pull the bar for use. This enables the user to easily access the bar and pull rather than to lift the bar from the keeper. Further helps the worker who works high in the air with multiple heavy tools on a belt.

The angle L bracket sits on top of two ½″ Fender washers, which are on top of the back plate, which sits on top of one ½″ inch Fender washer. These pieces are aligned by the ½″ center hole in the back plate and the use of the ½″ diameter steel rod. The steel rod is then welded to the washer on the opposing angle bracket side or back side.

Then the actual angle bracket is welded through the ½″ hole to the ½″ diameter alignment rod. Thus creating a swivel. The leather piece is installed with the hardware shown in FIG. 5-6 to create the loop for the attachment to a mans tool belt.

The metal assembly is polished to a smooth to the touch unpainted finish. The leather is burned around the edges to seal and preserve. The leather loop is created by folding the piece of four inch wide by nine inch long by 3/16 inch thick leather strip folded in half and mounting the plate through the 3/16th inch four corner holes.

The hardware attaches through a single layer of leather to create the loop at the top of assembly and at aches both layers at the bottom of assembly to make the open loop in order to slide the tool holder onto a tool belt. The four 10-24×1″ inch round head machine screws inserted into the corner holes are bolted tightened and cut to the top of the nut height then marred with a hammer to secure from unscrewing.

Finished product color printed photographs contain a sufficient number of views to constitute a complete disclosure of the appearance of the utility/design of the Model T. Sleever Bar Design in use.

FIG. 1. Shows finished product on belt loop with insertion of sleever bar.

FIG. 2. Shows finished product on belt to demonstrate user insertion of sleever bar.

FIG. 3. Shows sleever bar in upright position secure in the holder.

FIG. 4. Shows sleever bar in a holding position

FIG. 5. Sleever bar is shown by carrier while in kneeling position. The sleever bar is inserted into the Model T. Sleever bar holder easily from any position iron worker positions himself in.

FIG. 6. Sleever bar is shown in swivel horizontal position.

FIG. 7. The Model T. Sleever Bar Holder will swivel 360 degrees. The force of gravity swivels it back into the upright position when it is not in use.

I claim:

1. The Model T. Sleever Bar Holder is a new carrier/keeper for a Sleever bar tool. Iron workers use a Sleever bar tool on the job everyday. The Model T. Sleever bar holder swivel's 360 degrees. The swivel feature allows the bar to spin when the bar needs to be used yet it will not come out of or slip from the holder. The feature of the leather loop attached to the steel plate allows the Sleever bar holder to slide easily on to an existing tool belt. The Model T. Sleever Bar holder is hand crafted it rides high on the belt by a tunnel leather loop attached to a steel plate. Substitute specification contains no new matter.

2. The utility feature of the Sleever bar holder further provides a means to carry a sleever bar tool used by iron workers in the Iron working industry. The holder is useful and necessary.
